(19) United States
(12) Patent Application Publication
(10) Pub. No.: US 2011/0272350 A1
(43) Pub. Date: Nov. 10, 2011

(54) Methods for Treatment of Waste Activated Sludge

(76) Inventors: Paul SKILLICORN, Austin, TX (US); David YATES, Greenville, NC (US)

(21) Appl. No.: 12/775,861

(22) Filed: May 7, 2010

(51) Int. Cl. C02F 11/02

(52) U.S. Cl. 210/616

(57) ABSTRACT

A process for treating waste primary or activated sludge solids that have been removed to a digester phase of the activated sludge process through the use of powdered natural lignocellulosic materials (PNLM) and/or powdered kenaf core (PKC). These materials help this process by: (a) thickening of primary and/or waste activated sludge through adsorption, attached growth and achieving closer proximity of organisms by stimulating reduction of their associated ECP substance; (b) enhancing endogenous reduction of primary and/or waste activated sludge by thickening (see above) and improving the ratio of available carbon to available nitrogen by delivering a continuing gradual release of sugar from degrading PNLM and/or PKC; (c) enhancing the speed of endogenous reduction of primary and/or waste activated sludge—through higher efficiencies (same processes as above); and (d) improving dewatering characteristics of wasted primary and/or wasted activated sludge solids (through reduction and breakdown of ECP materials and higher densification of solids).

### BACKGROUND OF THE INVENTION

1. Field of the Invention

The present invention relates to the treatment of wastewater, such as, for example, municipal, industrial or concentrated animal feeding operation (CAFO) wastewaters.

2. Description of the Prior Art

Aggregation of volatile solids is typically a necessary process of wastewater treatment, regardless of the overall treatment process. In activated sludge processes these solids are aggregated as a function of both primary and secondary clarification. Fixed film processes similarly use primary filtration or clarification to separate and remove influent volatile solids. Lagoon systems employ more simple sedimentation techniques. These aggregated volatile solids must then be reduced in volume, where possible, and the resulting residual solids disposed of. Even passive lagoon systems eventually require residual solids to be excavated and disposed of. The cost of such disposal, regardless of the method used, is becoming increasingly costly as a result of increasing nutrient pressure on land and tightening regulation of pollutant discharge into the environment. There is growing recognition that the key to lowering the cost of volatile solids disposal is to employ biological and physical processes to reduce the final volume of material that must be disposed of. Two general approaches are employed: lowering the final moisture content of wasted sludge and/or physically reducing its final solids volume by rendering a portion of it to gas which can either be burned or volatilized and other portions of it to dense, mineralized, chemically and biologically inert grit which is then subject to easy separation and removal and inexpensive final disposal.

The most common method for reducing the moisture content of wasted sludge designated for final disposal still relies on the largely natural process of settling or sedimentation of wasted sludge solids in a receiving vessel and then decanting the resultant clarified supernatant liquid back into the active treatment process. This process takes many forms and is typically interspersed with periods during which moderate aeration takes place within the receiving vessel—the objective being to stimulate endogenous biological reduction of sludge solids and/or maintain odor within acceptable limits. Aeration covers the full range of moderate to intense and continuous to none whatsoever. Increasingly, notably in larger wastewater treatment plants, methods for reducing the moisture content of sludge rely on chemical augmentation with polymers and dewatering of the resulting augmented floc with high speed centrifugal devices or continuous, belt presses. Dissolved air flotation (DAF) is also used to assist such processes.

Chemical and biological processes for reducing the physical volume of wasted sludge solids has received considerable attention from engineers, biologists, chemists and designers in recent years. This has stimulated development of technologies that have moved beyond the most commonly deployed approach, anaerobic digestion.

The “new science” of wasted sludge solids volume reduction is focused on enhancing endogenous sludge reduction before wasting occurs—within the activated sludge process itself. In so doing, these new approaches claim to reduce the amount of activated sludge that must finally be disposed of. These processes typically take an engineered approach to denaturing, or physically altering—indeed, ultimately partially sterilizing and even lysing—a portion of the return activated sludge before again discharging it back into the activated sludge influent stream. A recitation of methods used to accomplish this is impressive, ranging from physical smashing of sludge flocs and attendant bacteria, to ultrasonic, ozone, ultraviolet, pH manipulation, extreme temperature manipulation and anaerobic processes. The principal goal of these various processes is to render the bacteria in activated sludge inoperative and to make their substance available to successor bacteria. Breaking up the extra cellular polysaccharides or polymers (ECP) glycocalyx that surround and inhibit access to those bacteria is a key objective central to almost every one of these new processes. Lysing bacterial cell membranes is an additional objective served by the most vigorous techniques—notably those employing physical, temperature or chemically induced breakdown (notably lysis) of one kind or another.

U.S. Pat. No. 7,481,934 is incorporated herein by reference, and included as prior art background, along with all patents and documents cited during prosecution, namely U.S. Pat. Nos. 7,157,000, 6,461,510, 5,302,288, 5,192,442, 5,068,036, 4,919,815, 4,897,196, 4,810,386, 4,292,176, 4,073,722, 4,069,148, 3,957,632, and 3,904,518; US Patent Application Publication Nos. 20020249451 and 20020148780.

U.S. Pat. No. 7,481,934 by Skillicorn, relates to the present invention, and is invented and owned by a common entity; while this patent provides relevant prior art, the present invention provides additional beneficial treatment of wastewater—notably enhanced reduction of wasted activated sludge volatile solids—at or proximal to the digester stage of the process, which is a surprising discovery as an alternative to treating the waste stream at other points in the process as described and taught in said patent.

### SUMMARY OF THE INVENTION

The present invention relates to the treatment of wasted activated sludge solids, wasted primary sludge solids, aggregated CAFO waste solids, aggregated DAF-generated solids, or any other form of fine particle aggregated waste solids having a high volatile solids portion this is disposed of in a liquefied form wherein water comprises the overwhelming portion of said liquid carrier. The systems and methods of the present invention address the longstanding, unmet need for efficient and low cost treatment of wastewater using activated sludge, in particular, focused on treatment of the wastewater at the digester stage in the process. Treatment, notably reduction in the final discharge volume of volatile solids, is effected by augmentation with finely powdered natural lignocellulosic material at or proximate to a digester stage—whether aerobic or anaerobic—of said processes. Most commonly in treatment of these wasted materials, the pH of the wasted materials is from about 4 to about 11, or is treated with chemicals so as to adjust the pH into this range. Also, commonly the wasted materials contain about 25 to about 10,000 mg/l of total suspended solids, with the volatile solids portion of the wasted materials being significant, generally greater than 25%.

It is an object of this invention to provide an improved wasted volatile solids treatment process that is generally applicable to treatment of municipal, industrial and CAFO waste streams at a digester stage within the process which may differ significantly as to their characteristics—ranging from high to low with respect to BOD, COD, TOC, suspended solids, dissolved material, total nitrogen, total phosphorus, and presence of greases, oils, toxins and heavy metals.

It is an object of this invention to provide both physical and biological treatment processes that can more efficiently and economically dewater and/or reduce the volatile solids content of wasted solids derived from municipal, industrial and CAFO waste streams at or proximate to a digester stage of the process through the supplementary use of powdered kenaf core (PKC) and other finely powdered natural lignocellulosic materials (PNLM). It is another object of this invention to provide an improved PNLM- and/or PKC-enhanced post-activated sludge process that significantly reduces final sludge output and therefore sludge disposal costs.

Yet another object of this invention is to provide a PNLM- and/or PKC-enhanced digestion process that significantly enhances the floc and or settling characteristics of wasted primary and/or secondary activated sludge solids in an aerobic digester stage of the process,—thus increasing the speed and efficiency of aerobic digester sludge settling, enhancing the speed and efficiency of clarified supernatant decanting and therefore increasing the total material throughput capacity of those aerobic digesters.

A further object of this invention of to provide a PNLM- and/or PKC-enhanced digestion process that significantly enhances the efficiency of anaerobic digestion of wasted primary or secondary sludge by helping to break up ECP (glycocalyx) slime barriers, increases the density of the wasted sludge (higher percentage of solids), increases access by anaerobes to wasted volatile solids, and increases the carbon-to-nitrogen ratio of the material being digested—thus increasing the speed and efficiency of anaerobic digestion, increasing throughput capacity of anaerobic digesters, increasing biogas output and the methane content of biogas produced, and reducing and densifying the final sludge that must subsequently be disposed of. Accordingly, a broad embodiment of this invention is directed to any process for processing and/or removal and disposal of fine particle sludge containing a significant volatile solids component and comprising, in combination, the steps of:

(a) contacting a stream of wasted, fine particle sludge containing a significant volatile solids component at or proximate to an anaerobic or aerobic digester stage of the process with a measured amount of fresh PNLM and/or PKC; and
(b) ensuring the PNLM and/or PKC are well mixed with and into the wasted sludge;

These and other aspects of the present invention will become apparent to those skilled in the art after a reading of the following description of the preferred embodiments when considered with the drawings, as they support the claimed invention.

### BRIEF DESCRIPTION OF THE DRAWINGS

FIG. 1 is a schematic flow diagram of one embodiment of the invention in which primary sludge and/or secondary sludge from an activated sludge wastewater treatment plant are separated from an influent waste stream and a treatment cycle, respectively, and sent directly to an aerobic and/or anaerobic digester for further treatment preparatory to final disposal.

FIG. 2 is a schematic flow diagram of one embodiment of the invention in which primary sludge and/or secondary sludge from an activated sludge wastewater treatment plant are separated from an influent waste stream and a treatment cycle, respectively, and sent directly to a series of facultative tanks (open topped, but without aeration) for thickening and holding preparatory to final disposal.

FIG. 3 is a schematic flow diagram of another embodiment of the invention in which CAFO wastes are sent directly or post-lagoon treatment to aerobic and/or anaerobic digesters for treatment or further treatment, respectively—preparatory to final disposal.

FIG. 4 is a schematic flow diagram of yet one more embodiment of the invention in which waste solids containing a high volatile solids component are removed by filtration from an industrial process and sent directly to aerobic and/or anaerobic digesters for further treatment preparatory to final disposal.

### DETAILED DESCRIPTION

Referring now to the drawings in general, the illustrations are for the purpose of describing a preferred embodiment of the invention and are not intended to limit the invention thereto. U.S. Pat. No. 7,481,934 is incorporated herein by reference in its entirety.

The present invention provides an improved process for treating wasted sludge having a significant volatile solids content in which powdered natural lignocellulosic material (PNLM), especially powdered kenaf core (PKC), is added to the wasted sludge, preferably, in, at or proximal to the digester stage of the process. The preferred kenaf core material has a specific surface area greater than about 100 square meters per gram, more preferably greater than about 200 square meters per gram, more preferably greater than about 400 square meters per gram, and still more preferably greater than about 500 square meters per gram. Commonly such kenaf core is in powdered form and has a particle size such that at least 50 percent of it will pass through 100 mesh per inch sieve, although generally about 70 to about 99 percent will pass through such a sieve. The present invention aids in treatment by improving system efficiencies and lowering costs. It is especially useful in lowering the final volume of sludge that is collected and/or produced as a function of such wastewater treatment processes—notably in a final digester or holding facility stage within such processes.

Preferably, wasted sludge having a significant volatile solids content is contacted with about 1 to about 5000 mg/l PNLM and/or PKC, more preferably about 1 to about 1000 mg/l is used. PNLM and/or PKC is generally used in an integrated, multi-step sludge thickening, dewatering, volume reducing and/or otherwise treating process. It can optionally be used in each step to enhance treatment/processing—providing physical and/or biological advantages to the various steps of the process. In instances where sludge is initially wasted to a receiving vessel and decanting of supernatant occurs to achieve a more dense, thickened sludge, use of PNLM and/or PKC will enhance settling of the PNLM- and/or PKC-fortified sludge and allow decanting of a greater volume of clarified supernatant than would otherwise occur. It is important in such instances that good mixing of the PNLM and/or PKC with the wasted sludge is first achieved and that some time subsequently be allowed for micro pockets of air trapped within the PKC and/or PNLM to dissolve and/or dissipate. Mixing may take place in the receiving vessel itself—either with a non-aerating mixer or an aerating mixer, in a pipe and attendant pump leading to the receiving vessel, and/or in a smaller, discrete vessel intended specifically for that purpose. Incorporation of PNLM and/or PKC has the immediate effect of thickening the sludge and therefore reducing the hydraulic volume of the material to be disposed of should no further post-thickening processing be scheduled to occur. The cost of disposing of a lesser hydraulic volume of waste sludge is, all things being equal, less than that of disposing of a greater hydraulic volume. Similarly, where the thickened sludge is subsequently subjected to further processing—whether belt-thickening, belt-pressing, aeration or even direct anaerobic digestion—that process will typically become more efficient, at the margin, because the material being processed has a higher solids-to-liquid ratio than it might otherwise have had.

The enhanced settling exhibited by PKC- and/or PNLM-fortified sludge is primarily a function of the massive surface area of PNLM—and particularly that of PKC. The natural affinity of small particle biomass (notably activated sludge bacteria) to attach to available surface areas—aided, in part, by the natural predilection of “attached” bacteria to lessen production of ECP—has the effect of creating a more dense floc than would otherwise occur. This effect is more pronounced with activated sludge solids because of the extreme amounts of ECP (sludge slime) associated with the product. PKC- and/or PNLM-fortified activated sludge solids will also dewater more effectively than might otherwise occur, in part because of the disruption to ECP brought about by the PKC and/or PNLM.

A PKC- and/or PNLM-fortified sludge that is maintained within an acceptable pH range, when aerated, and subsequently left again to settle, will continue to yield additional clarified supernatant that can be decanted, while also continuing to produce an increasingly dense sludge. The speed at which this occurs is a function of the nature of the sludge, the relative amount of PKC and/or PNLM added, the level of aeration, the duration of aeration, the duration of settling and the rate (if any) at which new materials—fresh sludge and/or fresh PKC and/or PNLM—are added and “partially processed” materials are discharged or withdrawn. While the multidimensional nexus of these many individual performance curves makes final output in any given instance difficult to predict, the “final sludge” will be more dense, and there will be less of it (measured by hydraulic volume) than were PKC and/or PNLM not used (within the recommended dosing range).

In batch mode, during periods of intermittent aeration and settling, the sludge quickly approaches a circumstance wherein the food to microorganism ratio approaches zero. This results in continuing senescence of more frail and vulnerable organisms which then breakdown, decompose and contribute their substance as food to successor organisms. These “turnovers” contribute CO2 and N (iterations of nitrification and denitrification) to the atmosphere and biologically inactive “minerals” to the sludge itself—with the resulting sludge being somewhat less as to total solids and somewhat more dense in its makeup. Beyond availability of dissolved oxygen (contributed by the cycles of aeration), a major constraining factor on the speed at which this turnover process iterates is the availability, at the margin, of available carbon. The available carbon to nitrogen ratio of senesced bacteria is approximately 5. A ratio ideal for bacterial growth (and hence turnover) ranges between 30 and 60. The carbon to nitrogen ratio of PKC and PNLM ranges between 300 and 400—but the carbon, locked up in the predominant cellulose, hemicellulose and lignin, only becomes available as those materials are gradually broken down (hydrolyzed). Therefore, additives with carbon/nitrogen ratios in the range of between about 100 and about 500 are acceptable for use according to the present invention. Kenaf fiber, which has approximately 30% less lignin than does wood fiber, which constitutes the bulk of commercially available lignocellulosic materials, breaks down (hydrolysis) somewhat more quickly than does wood—providing, at the margin, in a favorable location immediately adjacent to the senesced and still attached bacteria, the critical carbon (as glucose) that the successor bacteria require. While not providing enough glucose at any given time to stimulate an explosive growth of any given successor bacteria, the seemingly “timed release” of glucose by the gradually oxidizing kenaf fiber continues feeding successive iterations of bacteria (the “turnover”) with high efficiency. Each iteration—moving from one species of bacterium to another—continues the inexorable process of releasing CO2 and N to the atmosphere and contributing increasingly dense, biologically inactive mineralized grit to the sludge. Kenaf, in particular, is a very efficient catalyst promoting the endogenous reduction of sludge.

Wasted activated sludge intended for anaerobic digestion is notorious for being “problematic.” Two factors contribute most to this notoriety—inhibition of the process by relatively high ECP loadings and an unfavorable carbon-to-nitrogen ratio. Addition of PKC and/or PNLM to the sludge can help mitigate both problems. As has already been noted, it can also lower the time and cost of thickening the sludge to a level (5% to 10% solids) considered ideal for anaerobic digestion. Again, the timed-release of glucose from the continuing hydrolysis of kenaf, in particular, fits well with the continuing, but gradual breakdown of the ECP and senesced bacteria that make up the bulk of the sludge. A PKC- and/or PNLM-fortified sludge can be expected to produce significantly more valuable methane while also achieving a significant reduction of the final sludge (which must finally be disposed of). Expectation of a 50% improvement in each factor would not be unreasonable.

In circumstances where initial sludge is drawn from industrial sources, examination of the carbon-to-nitrogen ratio of the sludge will provide an early indication as to the magnitude of the potential gains to be achieved by PKC- and/or PNLM-fortification. A low ratio (<10) signals high potential gains, while a high ratio (>50) will indicate lower potential gains. Regardless of the C/N ratio, care should be taken to ensure that particle size is brought to a favorable size (pass through 100 mesh screen) preparatory to processing. This can be done using a variety of commercially available processes. The same general rules hold for CAFO wastes, where both cattle and swine wastes will typically be favored over wastes (such as those from poultry production) that contain lignocellulosic litter material.

In any instance where supernatant is withdrawn from a settling phase during processing of PKC- and/or PNLM-fortified sludge, care should be taken to dispose of it in a manner consonant with requirements mandated by local regulatory agencies. Disposal of final sludge should, similarly, conform to mandated requirements. Maintenance of pH, hydraulic loading and PKC and/or PNLM dosing during processing should, of course, always follow prescribed guidelines.

PKC and/or PNLM dosing can use any method which successfully introduces an intended amount of the material into the target waste stream at an intended location in a timely manner without contravening any state or federal safety codes or causing risk to attendant humans or structures. Users should always be cognizant that PKC and/or PNLM, as finely powdered lignocellulosic materials, can, under certain circumstances, result in explosive ignition. Dosing methods that have been used with success include full immersion of dissolving plastic bags, manual emptying of conventional plastic bags, emptying of material both manually and by mechanical means from plastic and wooden containers and bulk shipping bags. The most satisfactory means by which dosing has been achieved is by specialized, mechanical lignocellulosic powder feeding apparatus that also employs an encompassing spray to suppress dust. PKC and/or PNLM can be stored in conventional silos and supplied to the feeding apparatus using gravity, mechanically-assisted gravity, mechanical and pneumatic means.

PKC and/or PNLM are not harmful to humans experiencing superficial exposure to the materials. There is no known risk of cancer or other diseases due to long term superficial exposure. Significant exposure to lungs and other internal organs can, however, produce significant immediate discomfort and may be expected to result in increased risk of serious respiratory and possibly even gastric disorders.

Thus, a method for treating waste in a waste digestion process according to the present invention includes the method steps of mixing lignocellulosic particles into the waste sludge and digesting the sludge and particle mixture; thereby reducing the final disposal volume of solids for the waste digestion process. In this process, the combined cellulose and hemicelluloses content of the particle is preferably greater than about 30%. More preferably, the cellulose content of the particle is greater than about 60%. The lignocellulosic particle is preferably added at a rate of between about 5% and about 40% of total solids. The lignocellulosic particle preferably has a specific surface area greater than about 100 square meters per gram; more preferably, greater than about 200 square meters per gram; even more preferably greater than about 400 square meters per gram; even more preferably greater than about 500 square meters per gram. Preferably, the particle size is about 100 mesh.

The lignocellulosic particle is preferably a powdered natural lignocellulosic material and can consist of sphagnum moss, hemp hurd, jute stick, balsa wood, other hard and soft woods, kenaf core, crop straws, grass specie stems, bamboo specie stems, reed stalks, peanut shells, coconut husks, pecan shells, other shells, rice husk, other grain husks, corn stover, other grain stalks, cotton stalk, sugar cane bagasse, conifer and hardwood barks, corn cobs, and combinations thereof.

The digestion process can be anaerobic, aerobic, or facultative.

### First Preferred Embodiment

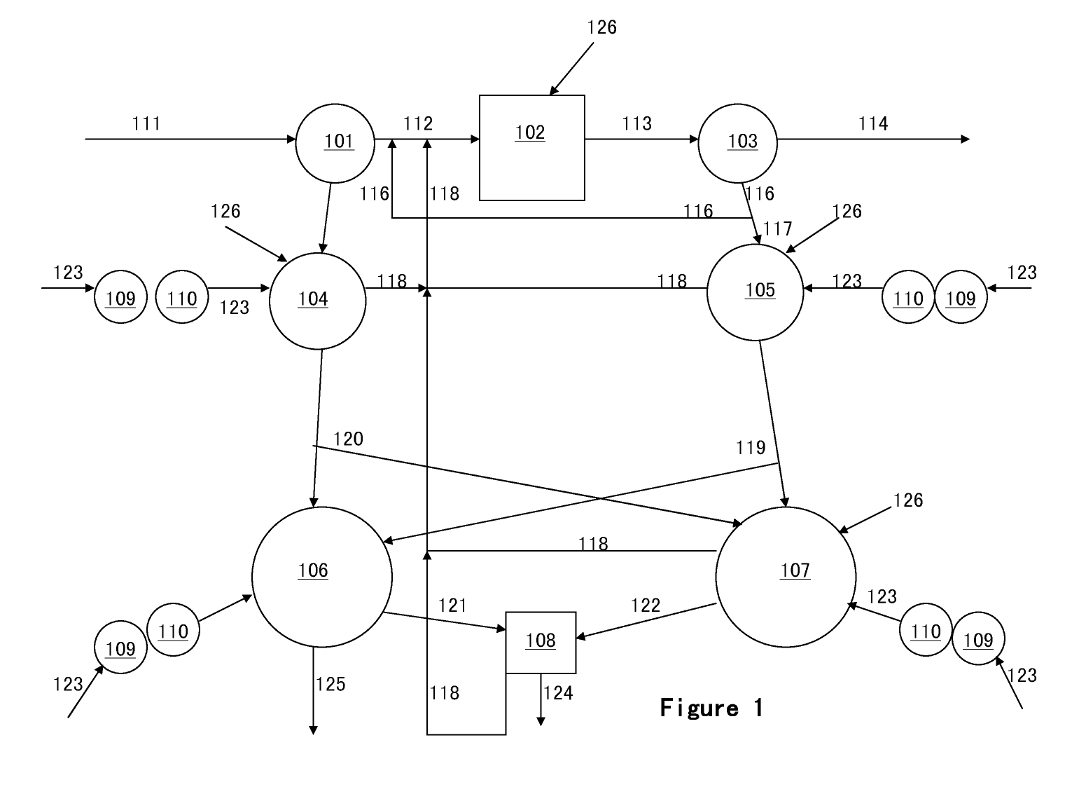

Referring to FIG. 1, following conventional preliminary treatment (grit and trash removal) raw influent wastewater 111 is optionally passed through primary clarifier 101, with clarified influent 112 (or raw influent 11 directly) passing to activated sludge system 102. Activated sludge system 102 can use any one of a wide range of generally accepted approaches to activated sludge treatment before passing mixed liquor 113 to secondary clarifier 3. Clarified effluent 114 is subsequently subjected to optional fine filtration to remove residual TSS and conventional disinfection (chlorine, UV or Ozone) before being discharged. Return activated sludge 116 is recovered from the clarifier and cycled back to the front of the activated sludge system 102, where it is mixed with the primary clarified raw influent (or, unclarified raw influent if primary clarifier 101 is not used or bypassed) and cycled back through the activated sludge system 102 again—serving continuously, to reseed the process.

Primary sludge 115 is passed to receiving basin/tank 104 while waste activated sludge 117 (a discretionary portion of return activated sludge 116) is passed from the secondary clarifier to receiving basin/tank 105. Optionally, receiving basin/tanks 104 and 105 can be coincident, with both primary sludge 115 and waste activated sludge 117 both passing through to a single receiving basin/tank preparatory to final passage to either anaerobic digester 6 or aerobic digester 107.

The primary objective served in receiving basin/tanks 104 and 105 is to thicken sludge—notably by removing water. Several approaches may be employed: (a) settling and decanting supernatant; (b) addition of polymer and separation of a thickened sludge using dissolved air flotation; and (c) addition of a polymer and separation of a thickened sludge with the aid of a belt thickening apparatus. A further objective served in receiving basin/tanks 104 and 105 is to achieve some reduction in the total sludge solids volume—endogenous removal of sludge solids. This can be achieved, at the margin, by aerating 126 for reasonably extended periods of time. Successive iterations through periods of aeration, settling and decanting supernatant will continue both to thicken the remaining sludge and to remove solids. Marginal returns on both results will, typically, diminish with each iteration, gradually approaching zero, over time. It is here, at receiving basin/tanks 104 and 105, that PKC and/or PNLM may first be introduced.

Two objectives are served by introducing PKC and/or PNLM 123 through the powder silo 109 and automated powder feed system 110 to receiving basin/tanks 104 and/or 105: (a) improved thickening through enhanced settling of sludges 115 (primary) and 117 (waste activated) during iterations of aeration 126, settling and decanting supernatant 118; and (b) enhanced endogenous reduction of sludge solids through improvement of the physical context of sludge being aerated and improvement of the carbon to nitrogen ratio of that sludge. Where thickening involves use of polymers in combination with either dissolved air flotation (DAF) and/or belt-thickening, operators may elect not to introduce PKC and/or PNLM 123 during this intermediate state—preferring instead, to introduce the materials at the subsequent digester stages (106 and/or 107). Regardless, supernatant and/or DAF/thickening belt residual fluids 118 removed from the sludge at this stage are recycled back to the front of the activated sludge system 102 for subsequent treatment.

Thickened sludge 119 and 120 from receiving basin/tanks 104 and/or 105, respectively, are passed either to anaerobic digester 6 or aerobic digester (holding tank/basin) 107. Most wastewater treatment plants will employ only one approach, but some elect, nevertheless to operate both, typically choosing to use anaerobic digestion for primary sludge and aerobic digestion for secondary waste activated sludge.

With respect to aeration tank/basin 107, and as with receiving tank/basins 4 and 105, two objectives are served by introducing PKC and/or PNLM 123 through the powder silo 109 and automated powder feed system 110: (a) improved thickening through enhanced settling of thickened sludges 120 (primary) and 119 (waste activated) during iterations of aeration 126, settling and decanting supernatant 118; and (b) enhanced endogenous reduction of sludge solids through improvement of the physical context of sludge being aerated and improvement of the carbon to nitrogen ratio of that sludge. If PKC and/or PNLM 123 has already been added at either receiving tank/basin (104 and 105) the wastewater treatment plant operator may elect to refrain from adding additional PKC and/or PNLM 123. Alternatively, he/she may elect to augment existing concentrations of PKC and/or PNLM 123 in sludges 120 and 119 coming from receiving tank/basins 4 and 5 respectively. Where sludges 120 and/or 119 may contain no PKC and/or PNLM 123, the operator should elect to add some (123) from the attendant silo109 and powder feed apparatus 110.

Wastewater treatment plant operators are advised to adopt an operating protocol for aeration tank/basin 7 which follows recommended dosing of PKC and/or PNLM 23, and then steps through several extended iterations of aeration 26, settling and decanting supernatant 18. In so doing the amount of treated sludge 22 discharged for final dewatering 8 and/or immediate disposal 24 is significantly less than what is normally produced at this final stage.

With respect to anaerobic digester 106, two objectives are served by introducing PKC and/or PNLM 123 through the powder silo 109 and automated powder feed system 110: (a) improved physical presentation of the sludges (119 and 120)—notably with the ECP of thickened activated sludge 120 having been broken up and dispersed, and (b) an improved carbon to nitrogen ratio that will be more amenable to the anaerobes that must subsequently breakdown the senesced aerobic bacteria that comprise the bulk of the thickened waste activated sludge 120, in particular. If PKC and/or PNLM 123 has already been added at either receiving tank/basin (104 and 105) the wastewater treatment plant operator may elect to refrain from adding additional PKC and/or PNLM 123 at this stage. Alternatively, he/she may elect to augment existing concentrations of PKC and/or PNLM 123 in sludges 120 and 119 coming from receiving tank/basins 104 and 105 respectively. Where sludges 120 and/or 119 may contain no PKC and/or PNLM 123, the operator should elect to add some (123) from the attendant silo and powder feed apparatus 110—notably to the thickened waste activated sludge 119 coming from receiving tank/basin 105.

Operators of the anaerobic sludge digester 106 will discover that the benefits of PKC- and/or PNLM-augmentation 123 will manifest as significantly enhanced gas output 125 and significantly lowered volume of final digested sludge solids 121 destined for final dewatering 108 and/or immediate disposal 124.

Final dosing of PKC and/or PNLM through digesters 106 and 107 will be a function of the nature and quality of sludges 119 and 120 and other site-specific and circumstance-specific variables. Developing an understanding of optimal dosing will be an empirical issue and may take a year or more to “pin down.” Optimal quantities for any given location are, nevertheless, expected to remain significantly below 10% of “other” sludge solids. Similarly, timing issues will be a function of available space and demand pressure on available facilities. Where opportunities exist to operate for longer, operators will gradually come to understand the nature of the tradeoff between operating costs (notably the cost of electricity consumed during aeration—but also such factors such as polymer costs) and sludge disposal costs.

### Second Preferred Embodiment

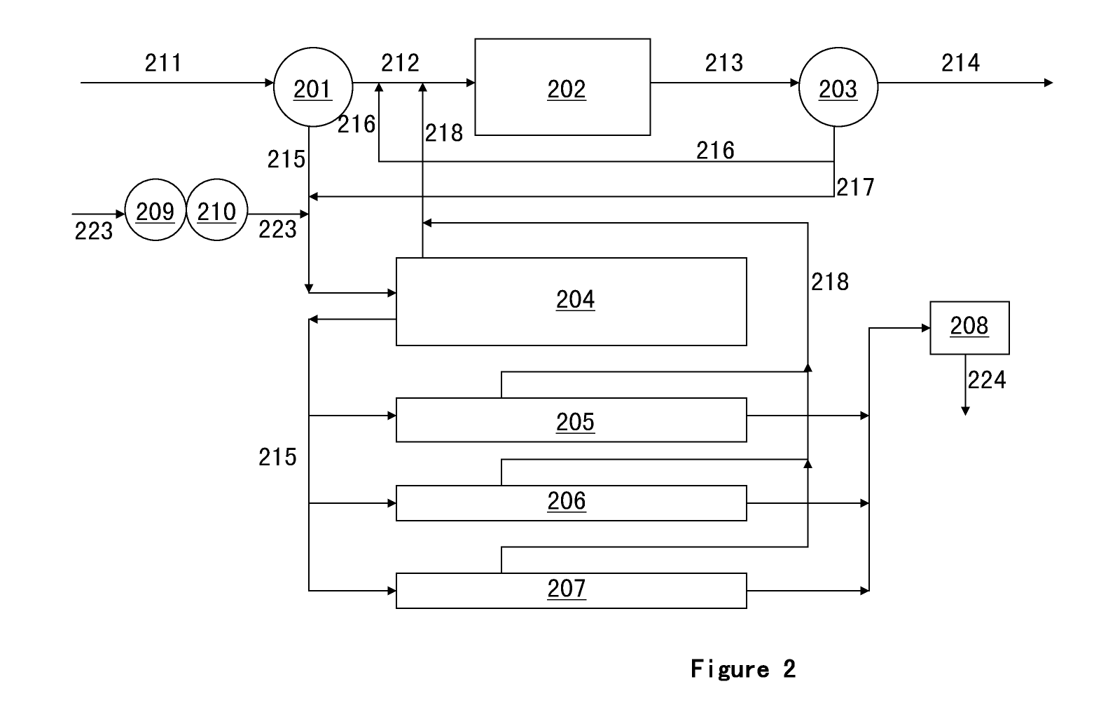

The embodiment illustrated in FIG. 2 depicts an activated sludge wastewater treatment plant similar to that presented in FIG. 1. It differs greatly from the first system, however, in the way it deals with, and disposes of sludge. As with the first, preferred embodiment, removal of primary sludge—and therefore dealing with it as a discrete intermediate product—remains an option. In practice, however, this is unlikely to be exercised—notably because: (a) the “food” that would be removed in the primary clarifier would prove beneficial in helping pseudomonas species and their heterotrophic brethren deal with the increasingly important function of converting residual nitrate to nitrogen gas (denitrification); and (b) the solids that might be removed in the primary clarifier can more easily be removed in the secondary clarifier. This discussion will, therefore, focus specifically on disposition of waste activated sludge (217).

PKC and/or PNLM 210 is stored in silo 209 and metered into the line transporting waste activated sludge 217 to receiving/decanting tank 204. Normal turbulence in this line—notably passing through at least one pump, is considered adequate to achieve optimal mixing. The mixed PKC- and/or PNLM-fortified sludge enters a quiescent receiving/decanting tank 204, where it then stratifies with existing, thickened PKC- and/or PNLM-fortified sludge already in the tank. As new sludge enters the tank, it displaces through an overflow stanchion, clarified supernatant that has separated from the settling sludge solids. This supernatant 218 is then returned to the head of the treatment plant where it is blended with the improved raw influent stream 211 and submitted to activated sludge treatment.

Recent PKC- and/or PNLM-fortified sludge wasted to receiving/decanting tank 204 is also fortified with small, micro bubbles of oxygen adherent to the massive surface area of the PKC and/or PNLM and trapped within the inner (notably the kenaf-based PKC). These, at the margin, are sufficient to energize intensified local bacterial action at the surface of the fiber that helps stimulate good bacterial attachment (both exterior and within the larger powder particles). The result is to create an increasingly dense sludge that settles ever lower in tank 204, releasing more clarified supernatant to the surface—supernatant that is subsequently “overflowed” through the stanchion back into the activated sludge system 202. When clarified supernatant is depleted, and sludge begins overflowing back to the aeration basins, it serves as a signal to the operator to transfer sludge from receiving/decanting basin 204 to long term storage basins 205, 206 and 207. There, facultative bacteria gradually come to predominate, with some turnover of successor bacteria subsequently taking place. In general, everything goes still, and except for the occasional “burping” to release methane buildup, quiescent conditions come to prevail. A gradually increasing layer of clarified supernatant serves to buffer release of unpleasant odors. Supernatant 218 is, occasionally, withdrawn from long term storage basins 205, 206 and 207 and returned to the head of the treatment plant where it is blended with the raw influent stream 211 or, optionally, the clarified raw influent stream 212 and submitted to activated sludge treatment. Other than supernating, and the occasional draw down of the receiving/decanting tank 204, the entire complex requires no work and almost no attention until thickened sludge is removed from long term storage basins 205, 206 and 207 for final disposal 224 through process 208—either composting, land application or landfill. Thickening of sludge using the non-aerated method depicted in FIG. 2 is considered adequate, but endogenous reduction of sludge is only minimal savings, therefore, less than optimal.

Fortification with the PKC and/or PNLM achieves four important results in this kind of completely passive facultative sludge handling system: (a) it serves to increase the density of the sludge; (b) it improves settling of that sludge; (c) it provides an early oxygen boost to help achieve attached growth; and (d) it provides a continuing carbon-boost to aerobic, facultative and anaerobic bacteria over the long haul—therefore stimulating significantly faster turnover of successive bacterial populations over time and therefore lowering total sludge volume. The final result is somewhat more dense final sludge but much less of it—and disposal cost savings favoring the municipality.

### Third Preferred Embodiment

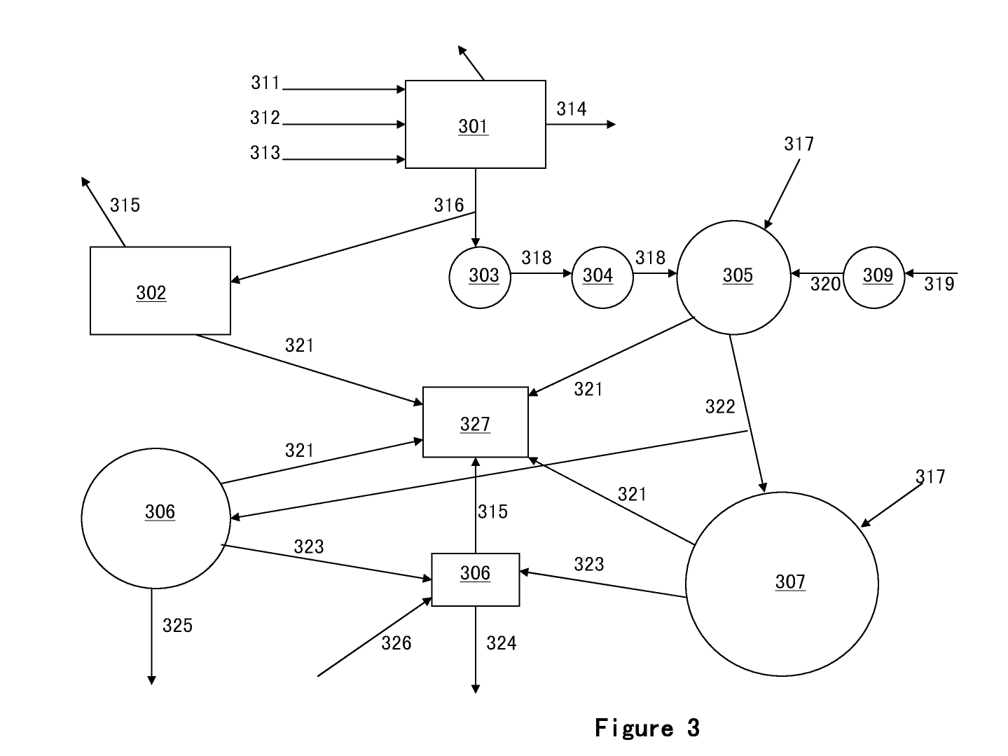

FIG. 3 depicts a generic, non-poultry CAFO (concentrated animal feeding operation) equipped with a full array of wastewater treatment options. In practice this would not normally be the case, with acutely cost-conscious swine, dairy or cattle farmers typically selecting only one wastewater treatment option. The hypothetical array depicted in FIG. 3 does, however allow a full discussion as to the relative benefits delivered by use of PKC and/or PNLM by non-poultry CAFO farmers.

The swine CAFO operation 301 is fueled by inputs of water 311, food 312 and young animals 313. Measurable output is grown and fattened animals 314 and wastewater 316. A less tangible, but nevertheless significant output is odor(not shown). Wastewater 316 may, optionally be directed to a traditional lagoon system 302 from which excess water 321 is land applied 310 according to crop “up take” criteria mandated by state regulatory authorities. Costs associated with the traditional system are minimal, but imposition of “no growth moratoria” associated with such traditional practices has rendered such a system incompatible with planned future growth. The farmer elects, therefore, to evaluate the “bottom line” value of using PKC- and/or PNLM-enrichment in either anaerobic 6 or aerobic 307 digesters and employing modified land application of residuals for final disposal. He will compare this with implementation of a low capital cost activated sludge system designed specifically for treating high BOD—low hydraulic loading, CAFO wastes.

Swine wastes are first subjected to simple grit removal 303 and then run through a fine grinder pump 304 before being transported to aerated receiving tank 305. Dosing with PKC and/or PNLM 320 takes place in the tank at a rate of about 10% or less of influent solids. The mixed sludge may optionally be subjected to periods of settling and decanting of clarified supernatant which is subsequently land applied 310 according to standards mandated by state regulatory authorities. Care should be taken to maintain pH close to 307 and alkalinity within a normal range by occasionally adding sodium bicarbonate. Mixed, PKC- and/or PNLM-fortified sludge 322 may then optionally be transferred to anaerobic digester 6 and/or aerobic digester 307.

Most common anaerobic digesters designed for CAFO wastes are batch operated and cycle through a full hydrolysis, acidogenesis, methanogenesis cycle every 30 to 45 days. Temperatures are ideally cycled between early thermophilic (around 50 degrees C.) during the first 10 days and then reduced to the mesophilic range (around 37 degrees C.) for the balance of the cycle. Heat can be supplied by burning a portion of the methane produced by the system—ideally using the cooling water of an engine driven by that methane. Adding 10% by weight PKC and/or PNLM should realize up to a 50% increase in methane output and up to a 25% decrease to total solids requiring final disposal.

Employing an identical 10% by weight PKC and/or PNLM dose, and processing the resulting fortified sludge in a significantly less expensive (capital costs) aerobic digester on an identical 45 day cycle while maintaining DO at approximately 0.5% for 90% of the time (cycling off every two hours using simple, automated timers to allow full anoxic conditions to repeatedly, but briefly take effect) and maintaining pH and alkalinity within the “normal” range with occasional sodium bicarbonate dosing, will realize a similar reduction (as much as a 75% decrease) in biosolids requiring disposal. An additional advantage is that nitrogen is fully removed by the aerobic method, simplifying, somewhat the task of final disposal. Ultimately the advantage of one approach over another is more a question of “willingness to invest” and “willingness to maintain” an anaerobic system that will not only be significantly more expensive to install, but also significantly more problematic to maintain in good working order. The advantage of using PKC and/or PNLM-fortification is, nevertheless, unambiguous.

Final wastes from either type of digester (anaerobic 306 or aerobic 307) may be “finished” using one of many approaches—such as, for instance, a sludge drying bed 308. Here, the small liquid residual would be land applied 315 and the dried solids 324 either incinerated or taken to a landfill.

### Fourth Preferred Embodiment

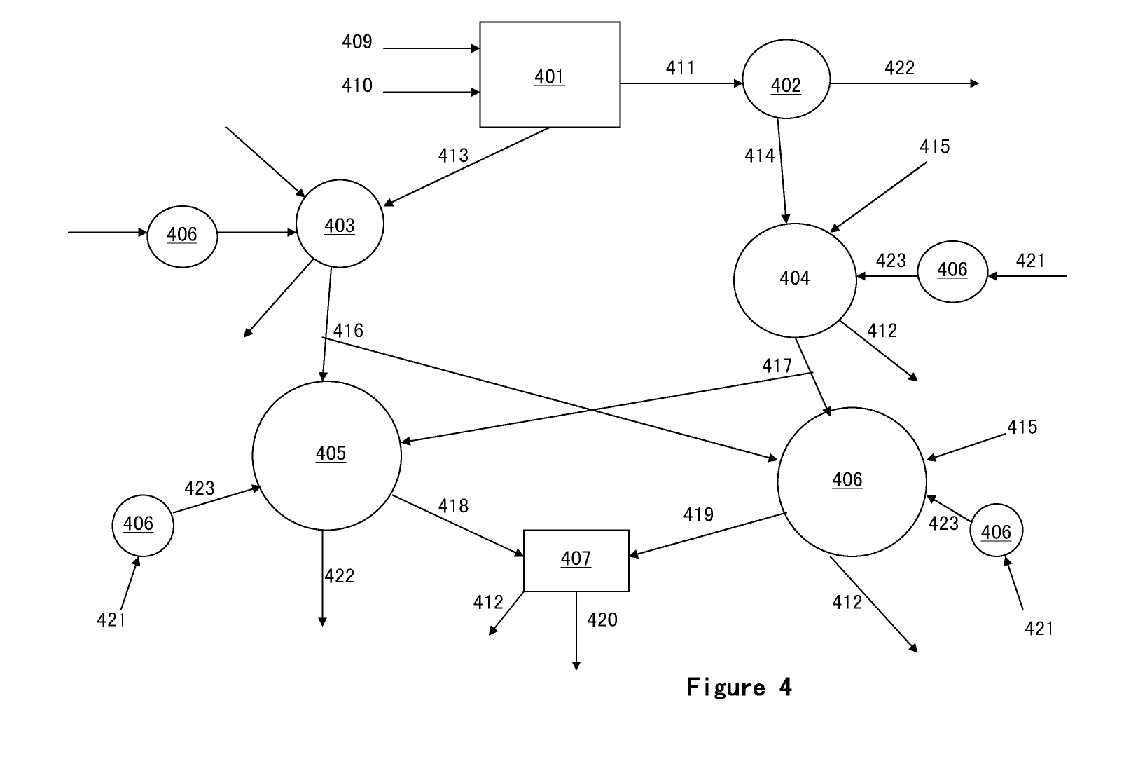

FIG. 4 depicts a generic industrial waste circumstance characteristic of a typical food processing factory—in this case a poultry slaughterhouse. Two “general” waste stream flows, one having high hydraulic loading 409 and one having high volatile solids loading 410, are directed through a DAF unit 401, with solids 413 being subsequently committed to “digesters” and (mostly) clarified liquids 411 being submitted to preliminary activated sludge treatment 402.

Wasted activated sludge 414 is collected in a receiving tank/basin 404, dosed with PKC and/or PNLM from material stored in silo 408 using powder feeding apparatus 423. This mixed sludge is subjected to intermittent aeration 415, settling, and decanting of supernatant 412 which is then directed to secondary activated sludge treatment. When the receiving tank/basin 404 is filled with sludge—no further decanting of supernatant is feasible—the PKC- and/or PNLM-fortified-sludge 417 is then sent either to anaerobic digester 405 or aerobic digester 6 for further processing and reduction.

DAF-generated sludge 413 is sent to receiving tank/basin 403, dosed with PKC and/or PNLM from material stored in silo 408 using powder feeding apparatus 423. This mixed sludge is subjected to intermittent aeration 415, but contingent on use of polymer in conjunction with the DAF separation, further settling, and decanting of supernatant 412 may not be possible. If supernatant is separable, it will be sent for further treatment. When the receiving tank/basin 404 is filled with sludge—no further decanting of supernatant is feasible—the PKC- and/or PNLM-fortified-sludge 416 is then sent either to anaerobic digester 405 or aerobic digester 406 for further processing and reduction.

Anaerobic digester 405 and Aerobic digester 406 will typically be operated in a manner similar to that described for the first preferred embodiment (above). Final, treated sludge solids will be subjected to dewatering 407 and finally disposed 420 of in a cost-effective manner. Liquids recovered from the aerobic digester 412 and sludge dewatering 412 will be committed to further treatment. Methane 422 produced by the anaerobic digester 405 can be used in a cost-effective manner to help recover some tangible value from the full process.

Dosing of PKC- and/or PNLM is expected to remain below 10% of “other sludge solids” on an equivalent dry weight basis. However, doses up 40% may be required in special cases. Doses of about 5% can also be effective in appropriate situations. Use of PKC- and/or PNLM realizes a significant increase in methane production when used with the anaerobic digester, and reduces final solids disposal requirements by as much as 50%. Disposal requirements associated with the aerobic digester may be reduced by as much as 75%.

From the foregoing description, one skilled in the art can easily ascertain the essential characteristics of the invention and, without departing from the spirit and scope thereof, make various changes and modifications to adapt it to various usages.

The following examples are merely illustrative and representative of our invention which is of considerably larger scope. These examples should not be considered limiting in any way.

### Example 1

An extended aeration activated sludge wastewater treatment plant treating an average municipal-industrial wastewater flow of approximately 250,000 gallons per day (MGD) was selected for full scale testing of our invention. This selection followed the rationale that such a plant fits the profile of a typical future user of the invention. Absent the anaerobic digester and the primary clarifier, the configuration of the plant generally conforms to the flow diagram depicted in FIG. 1. One major advantage was that the plant had two parallel aerobic digester “trains,” each comprising two tanks—a receiving tank and a finishing tank. This allowed an experimental train and a parallel control train. Each tank in each train could be aerated and mixed, turned off at will and allowed to settle, then supernated, with supernatant also being drawn off at will.

The experimental protocol called for quickly bringing up the concentration of finely powdered kenaf core (PKC) in the system to a level equivalent to 8.3% of total solids, or approximately 1,500 mg/l of waste activated sludge. The 100,000 gallon system was then continuously aerated with a single 25 HP surface aerator for 30 days, with measurements of total suspended solids, dissolved oxygen, pH, temperature, ammonia nitrogen and nitrate nitrogen and phosphorus taken once a week—or on 5 discrete occasions. Any requirement to waste sludge from the mixed liquor being managed in the treatment plant's oxidation ditch was split evenly between both trains and supplementation with PKC took place immediately thereafter. Overflow from the receiving tanks of both digesters was sent, as necessary to the finishing digesters in each train, but those two larger digesters would not be considered to be “in the study.”

Finely powdered kenaf core was prepared by separating the targeted kenaf core from its attendant, long bast fiber. This cleaned core fiber was then milled with a conventional hammer mill and passed through a 100 mesh (125 micron) screen The powdered kenaf was packed in 500 lb bulk bags and then trucked to the wastewater treatment plant site and loaded into the first receiving tank. Measurement of total suspended solids, dissolved oxygen, pH, temperature, ammonia nitrogen, nitrate nitrogen and phosphorus were taken immediately prior to dosing, and subsequently each week at the same time on the same day—5 measurements on each variable/parameter in total. Results are presented as follows:

TABLE 1
Example 1. Experimental Results
Example 1 Digester Train Data

| Variable | Exper/Cntr | Begin Wk 1 | End Wk 1 | End Wk 2 | End Wk 3 | End Wk 4 |
|---|---|---|---|---|---|---|
| Hydraulic Volume | E | 104,000 | 103,480 | 102,963 | 102,448 | 101,936 |
| (US gallons) | C | 104,020 | 103,499 | 102,980 | 102,464 | 101,951 |
| TSS | E | 18,820 | 15,056 | 12,346 | 10,494 | 9,130 |
| (mg/l) | C | 18,000 | 17,640 | 17,111 | 16,597 | 16,183 |
| DO | E | 0.50 | 0.48 | 0.47 | 0.48 | 0.49 |
| (mg/l) | C | 0.50 | 0.51 | 0.51 | 0.52 | 0.52 |
| pH | E | 7.10 | 6.96 | 6.89 | 6.85 | 6.85 |
| | C | 7.10 | 7.03 | 6.96 | 6.92 | 6.92 |
| Temp C. | E | 15.95 | 18.34 | 18.25 | 20.99 | 21.09 |
| (degrees C.) | C | 15.72 | 18.24 | 18.13 | 20.90 | 21.00 |
| NH₄ N | E | 5.23 | 6.80 | 8.16 | 6.53 | 4.57 |
| (mg/l) | C | 5.22 | 6.26 | 6.58 | 6.64 | 6.51 |
| NO₃ N | E | 2.35 | 9.40 | 11.28 | 5.64 | 1.13 |
| (mg/l) | C | 2.38 | 2.33 | 2.15 | 2.10 | 2.06 |
| P | E | 1.50 | 6.00 | 25.20 | 88.20 | 176.40 |
| (mg/l) | C | 1.56 | 3.12 | 6.55 | 14.41 | 31.71 |
| Settling Rate | E | 865 | 745 | 532 | 421 | 234 |
| (1 ltr mgs in 30 mins) | C | 845 | 828 | 803 | 779 | 748 |
| PKC Added (lbs) | E | 820 | | | | |
| Adjusted TSS | E | 18,820 | | | | |
| (mg/l) | C | | | | | |

From a wastewater treatment plant operator's perspective, the key results of this example are the very significant reduction in sludge solids, combined with the ability of the system to expel nitrogen—successfully iterating through cycles of nitrification and denitrification. Additionally, the improvement in settling allows a very significant reduction in hydraulic volume. Ultimately, given the nature of the “hauling contract” between the town and the sludge disposal contractor, the greatest impact on cost reduction is the hydraulic volume of the material hauled—greater, in fact, than the solids inherent in that volume, or the levels of nitrogen in that volume. Plant operators noted, with satisfaction, that the increase in performance (sludge solids and hydraulic volume reduction) was made possible without effecting any engineered changes to the existing treatment plant, whatsoever. The kenaf powder was supplied in bulk and delivered directly into the digester by the supplier. There was no need, whatsoever, for any storage or powder feeding apparatus. There was discussion, following the test, as to the possible benefits of installing a PKC bulk storage silo and attendant PKC feed apparatus. This would allow greater flexibility as to total system management—allowing incremental wasting to the digester and subsequent “topping up” with PKC. There was agreement that this would be a sensible investment—but agreement, nevertheless, that the investment was not necessary.

Finally, there was some discussion as to “What happened to the phosphorus.” The approximately 50% reduction in total solids achieved during the experiment should have resulted in a significant increase in phosphorus in the supernatant. While there was some increase, notably a doubling from 1.5 mg/l to just over 3.1 mg/l, this increase was not commensurate with the amount presumed to be released into the water by the degraded sludge. Opinion favored some kind of “mineralizing” effect that might have bound the phosphorus in residual grit that either remained in the bottom of the digester, or was otherwise “hauled” by the contractor disposing of the sludge. This matter remains to be fully resolved in more bench testing scheduled for the future that will allow more careful monitoring of total system mass balances. Finally, plant operators and managers considered the experiment to be a “success,” noting that, when the product became commercially available, they would be amenable to adopting its use.

### Example 2

An extended aeration activated sludge wastewater treatment plant treating an average municipal-industrial wastewater flow of approximately 5 million gallons per day (MGD) was selected for full scale testing of our invention. This selection followed the rationale that such a plant fits the profile of a typical “large plant” future user of the invention. Absent the anaerobic digester and the primary clarifier, the configuration of the plant generally conforms with the flow diagram depicted in FIG. 1. Waste activated sludge is first deposited in one of two small 150,000 gallon receiving tanks with supernatant removed passively through an overflow stanchion. Once full supernating becomes difficult, the contents of the receiving tank are evacuated to one of four “final” aerated digesters. Supernatant can also be removed from these tanks at the discretion of the operator, but this rarely occurs. Final disposal of sludge solids requires dewatering the material stored in the digesters with a belt press and then land applying the resulting 20% solids sludge. The configuration of the plant did not allow operation of a parallel control digester. Performance comparisons were therefore historical.

The experimental protocol called for filling one of the three digesters with waste activated sludge and then quickly bringing up the concentration of finely powdered kenaf core (PKC) in that 1.5 million gallon digester tank system to a level equivalent to 5.5% of total solids, or approximately 1,500 mg/l of waste activated sludge. Following introduction of 10,700 lbs of PKC, the 705,000 gallon system was then continuously aerated with a single 100 HP blower through bottom diffusers for 30 days, with measurements of total suspended solids, dissolved oxygen, pH, temperature, ammonia nitrogen and nitrate nitrogen and phosphorus taken once a week—or on 5 occasions.

Upon conclusion of the 5 week experimental period, digester contents were dewatered in the attendant belt press, producing 20% solids for final disposal (by land application). Finely powdered kenaf core was prepared by separating the targeted kenf core from its attendant, long bast fiber. This cleaned core fiber was then milled using a with a conventional hammer mill and passed it through a 100 mesh (125 micron) screen The powdered kenaf was packed in 500 lb bulk bags and then trucked to the wastewater treatment plant site and loaded into the first receiving tank. Measurement of total suspended solids, BOD₅, dissolved oxygen, pH, temperature, ammonia nitrogen and nitrate nitrogen and phosphorus were taken immediately prior to dosing, and subsequently each week at the same time on the same day—5 measurements on each variable/parameter in total. Results are presented as follows. Table 1. Example 2. Experimental Results

Example 2. Digester Experiment Data

| Variable | Exper/Cntr | Beg Wk 1 | End Wk 1 | End Wk 2 | End Wk 3 | End Wk 4 |
|---|---|---|---|---|---|---|
| Hydraulic Volume | E | 705,000 | 701,475 | 697,968 | 694,478 | 691,005 |
| (US gallons) | C | 705,000 | 701,468 | 697,954 | 694,457 | 690,978 |
| TSS | E | 29,770 | 25,305 | 22,015 | 18,713 | 16,280 |
| (mg/l) | C | 24,000 | 23,280 | 23,047 | 22,586 | 22,654 |
| DO | E | 4.20 | 5.04 | 5.04 | 5.11 | 5.19 |
| (mg/l) | C | 4.60 | 4.65 | 4.69 | 4.74 | 4.79 |
| pH | E | 7.10 | 6.96 | 5.98 | 6.28 | 6.79 |
| | C | 7.10 | 7.03 | 6.96 | 6.92 | 6.92 |
| Temp C. | E | 15.95 | 18.34 | 18.25 | 20.99 | 21.09 |
| (degrees C.) | C | 15.72 | 18.24 | 18.13 | 20.90 | 21.00 |
| NH₄ N | E | 6.23 | 18.69 | 56.07 | 28.04 | 14.02 |
| (mg/l) | C | 6.89 | 7.17 | 6.81 | 6.47 | 6.01 |
| NO₃ N | E | 2.35 | 9.40 | 14.10 | 7.05 | 1.41 |
| (mg/l) | C | 2.47 | 3.21 | 4.17 | 4.13 | 4.25 |
| P | E | 1.50 | 6.00 | 36.36 | 127.26 | 151.44 |
| (mg/l) | C | 1.56 | 3.43 | 7.21 | 15.86 | 34.88 |
| Settling Rate | E | 865 | 745 | 532 | 421 | 234 |
| (1 ltr mgs in 30 mins) | C | 867 | 841 | 832 | 816 | 818 |
| PKC Added (lbs) | E | 10695 | | | | |

PKC was introduced into the wastewater treatment plant by gradually releasing the powdered kenaf core directly into the top of the now full (of sludge) receiving tank. Full discharge of the measured amount of kenaf was achieved within 2 days—bringing the concentration of kenaf to 900 mg/l and total solids in the digester to approximately 19,000 mg/l. The 100 HP blower continued to operate throughout, with the boiling of rising bubbles helping quickly to mix the kenaf powder into the waste activated sludge.

From a wastewater treatment plant operator's perspective, the key results of this example are the very significant reduction in sludge solids, combined with the ability of the system to expel nitrogen—with successful iteration through cycles of nitrification and denitrification. Additionally, the improvement in settling allows a very significant reduction in hydraulic volume. Ultimately, given the nature of the “hauling contract” between the town and the sludge disposal contractor, the greatest impact on cost reduction is the reduction in volume of the material finally hauled. Reduction in hydraulic volume also played an important role because it allowed less use of (expensive) polymer and a lowering of machine time for the belt press. Plant operators noted, with satisfaction, that the increase in performance (sludge solids and hydraulic volume reduction) was made possible without effecting any engineered changes to the existing treatment plant, whatsoever. The kenaf powder was supplied in bulk and delivered directly into the digester by the supplier. There was no need, whatsoever, for any storage or powder feeding apparatus. There was discussion, following the test, as to the possible benefits of installing a PKC bulk storage silo and attendant PKC feed apparatus. This would allow greater flexibility as to total system management—allowing incremental wasting to the digester and subsequent “topping up” with PKC. There was agreement that this would be a sensible investment—but agreement, nevertheless, that the investment was not necessary.

Again, there was some discussion as to “What happened to the phosphorus.” The approximately 50% reduction in total solids achieved during the experiment should have resulted in a significant increase in phosphorus in the supernatant. While there was some increase, notably a doubling from 1.2 mg/l to just over 2.5 mg/l, this increase was not commensurate with the amount presumed to be released into the water by the degraded sludge. Opinion favored some kind of “mineralizing” effect that might have bound the phosphorus in residual grit that either remained in the bottom of the digester, or was otherwise “hauled” by the contractor disposing of the sludge. This matter remains to be fully resolved in more bench testing scheduled for the future that will allow more careful monitoring of total system mass balances.

### Example 3

Three small 1200 gallon digesters were constructed on the perimeter of the sludge holding facility of a wastewater treatment plant giving consideration to use of PKC. Each digester, constructed of molded plastic, was equipped with an aeration system capable of bringing the dissolved oxygen in 1000 gallons of 2% solids waste activated sludge to a level of 1.5 mg/l. The primary purpose of the three small units was to duplicate the basic sludge management system employed at that facility—a system similar to that described here as the second preferred embodiment (see above). One of the tanks served as a “no air” experimental tank, a second served as an “aerated” experimental tank, and the third served as a “no PKC” passive control.

Each tank was supplied, simultaneously, with 1000 gallons of waste activated sludge (having a total solids content of 4,322 mg/l) then being wasted to the wastewater treatment plant's sludge management system. Tanks one and two were then “fortified” with an identical 3 lbs of PKC, bringing their total solids content to 4,682 mg/l. Each tank was then mechanically mixed for 24 hours and then left to settle for 7 days. Settling rates were measured once each day during this interval. At the end of seven days, supernatant was removed from each tank. Tanks were again vigorously mixed for 7 days and again left to settle for 7 days. Again, supernatant was removed from each tank. Two tanks, the control and the “passive experimental tank” were then allowed to settle for an additional 4 weeks. Aeration then commenced in the aerated experimental tank on an hour on and hour off basis, 24 hours a day. During periods of aeration, dissolved oxygen (DO) was brought to, and subsequently maintained for the period at approximately 1.00 mg/l. Samples from each tank were tested for total suspended solids, dissolved oxygen, pH, temperature, ammonia nitrogen, nitrate nitrogen and phosphorus at the beginning of the trial (pre dosing) and at the same day on each following week—a total of 6 tests for each tank. The remaining hydraulic volume in each tank was also measured each week.

Results are presented below:

Example 3. Digester Experiment Data

| | | Beg Wk | End Wk | End Wk | End Wk | End Wk | End Wk | End Wk |
|---|---|---|---|---|---|---|---|---|
| Variable | Exper/Cntr | 1 | 1 | 2 | 3 | 4 | 5 | 6 |
| Hydraulic | E1 | 1,000 | 620 | 446 | 444 | 442 | 440 | 438 |
| Volume | | | | | | | | |
| (US gallons) | E2 (air) | 1,000 | 621 | 434 | 444 | 442 | 440 | 438 |
| | C | 1,000 | 730 | 657 | 654 | 650 | 647 | 644 |
| TSS | E1 | 4,682 | 6,796 | 8,496 | 7,391 | 6,504 | 5,789 | 5,210 |
| (mg/l) | E2 (air) | 4,682 | 6,790 | 8,730 | 7,158 | 5,727 | 4,696 | 3,898 |
| | C | 4,322 | 5,861 | 6,447 | 6,254 | 6,098 | 5,915 | 5,796 |
| Total Solids | E1 | 39.21 | 35.29 | 31.76 | 27.49 | 24.07 | 21.32 | 19.09 |
| (lbs) | E2 (air) | 39.21 | 35.29 | 31.76 | 26.63 | 21.19 | 17.29 | 14.28 |
| | C | 36.19 | 35.83 | 35.47 | 34.24 | 33.21 | 32.06 | 31.26 |
| DO | E1 | 0.08 | 0.02 | 0.01 | 0.01 | 0.01 | 0.01 | 0.01 |
| (mg/l) | E2 (air) | 0.08 | 0.02 | 0.01 | 1.04 | 1.06 | 1.07 | 1.09 |
| | C | 0.08 | 0.02 | 0.02 | 0.01 | 0.01 | 0.01 | 0.01 |
| pH | E1 | 7.10 | 6.96 | 6.40 | 5.89 | 5.59 | 5.48 | 5.32 |
| | E2 (air) | 7.10 | 6.96 | 6.68 | 6.15 | 6.08 | 5.96 | 6.56 |
| | C | 7.10 | 7.03 | 6.61 | 6.28 | 6.09 | 5.91 | 5.79 |
| Temp C. | E1 | 15.95 | 18.34 | 18.25 | 20.99 | 21.09 | 24.26 | 24.38 |
| (degrees C.) | E2 (air) | 15.84 | 18.29 | 18.19 | 20.94 | 21.05 | 24.24 | 24.36 |
| | C | 15.72 | 18.24 | 18.13 | 20.90 | 21.00 | 24.22 | 24.34 |
| NH₄ N | E1 | 5.23 | 15.85 | 33.28 | 49.92 | 74.88 | 112.31 | 168.47 |
| (mg/l) | E2 (air) | 5.25 | 16.10 | 37.04 | 29.63 | 14.82 | 5.93 | 3.56 |
| | C | 5.24 | 15.71 | 31.41 | 42.41 | 57.25 | 77.29 | 104.34 |
| NO₃ N | E1 | 2.35 | 7.12 | 7.69 | 7.84 | 8.00 | 8.16 | 8.32 |
| (mg/l) | E2 (air) | 2.36 | 7.24 | 16.64 | 13.31 | 6.66 | 2.66 | 1.60 |
| | C | 2.36 | 7.06 | 8.26 | 8.83 | 9.45 | 10.12 | 10.82 |
| P | E1 | 3.40 | 29.00 | 112.00 | 194.41 | 270.79 | 297.85 | 309.43 |
| (mg/l) | E2 (air) | 3.40 | 24.00 | 97.00 | 200.73 | 307.56 | 367.17 | 413.62 |
| | C | 3.68 | 23.64 | 86.84 | 156.11 | 196.26 | 198.07 | 188.97 |
| Settling Rate | E1 | 845.00 | 680.62 | 945.31 | 822.42 | 723.73 | 644.12 | 579.70 |
| (1 ltr mgs in 30 mins) | E2 (air) | 850.00 | 683.82 | 976.89 | 801.05 | 640.84 | 525.49 | 436.15 |
| | C | 848.00 | 791.00 | 878.89 | 852.52 | 831.21 | 806.27 | 790.15 |
| PKC Added | E & E2 | 820 | | | | | | |
| (lbs) | only | | | | | | | |

The aerated experimental tank experienced a 64% reduction in waste activated sludge solids during the six week experimental period. The non-aerated experimental tank and the non-aerated control tank experienced 51% and 14% reductions respectively. ANOVA analysis showed these differences to be significant (p<0.01).

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for treating waste in a waste digestion process, the method steps comprising:
a. mixing lignocellulosic particles into the waste sludge;
b. digesting the sludge and particle mixture;
thereby reducing the final disposal volume of solids for the waste digestion process.

2. The method of claim 1, wherein the combined cellulose and hemicellulose content of the particle is greater than about 30%.

3. The method of claim 1, wherein the combined cellulose and hemicellulose content of the particle is greater than about 60%.

4. The method of claim 1, wherein the lignocellulosic particle is added at a rate of between about 5% and about 40% of total solids.

5. The method of claim 1, wherein the carbon/nitrogen ratio of the lignocellulosic particle is between about 100 and about 500.

6. The method of claim 1, wherein the lignocellulosic particle has a specific surface area greater than about 100 square meters per gram.

7. The method of claim 1, wherein the lignocellulosic particle has a specific surface area greater than about 200 square meters per gram.

8. The method of claim 1, wherein the lignocellulosic particle has a specific surface area greater than about 400 square meters per gram.

9. The method of claim 1, wherein the lignocellulosic particle has a specific surface area greater than about 500 square meters per gram.

10. The method of claim 1, wherein the particle size is about 100 mesh.

11. The method of claim 1, wherein the lignocellulosic particle comprises powdered natural lignocellulosic materials.

12. The method of claim 10, wherein the powdered natural lignocellulosic material is selected from the group consisting of sphagnum moss, hemp hurd, jute stick, balsa wood, other hard and soft woods, kenaf core, crop straws, grass specie stems, bamboo specie stems, reed stalks, peanut shells, coconut husks, pecan shells, other shells, rice husk, other grain husks, corn stover, other grain stalks, cotton stalk, sugar cane bagasse, conifer and hardwood barks, corn cobs, and combinations thereof.

13. The method of claim 1, wherein the lignocellulosic particle is powdered kenaf core.

14. The method of claim 1, wherein the digestion process is anaerobic.

15. The method of claim 1, wherein the digestion process is aerobic.

16. The method of claim 1, wherein the digestion process is facultative.

17. A method for the treatment of contaminated fine particle sludge waste streams, the steps comprising:
a. contacting a stream of wasted, fine particle sludge containing a significant volatile solids component at or proximate to an anaerobic or aerobic digester stage of the process with a measured amount of fresh PNLM and/or PKC; and
b. ensuring the PNLM and/or PKC are well mixed with and into the wasted sludge; then
c. allowing the mixture to digest.
